(19) United States
(12) Patent Application Publication
(10) Pub. No.: US 2025/0015347 A1
(43) Pub. Date: Jan. 9, 2025

(54) SECONDARY BATTERY

(71) Applicant: DENSO CORPORATION, Kariya-city (JP)

(72) Inventors: Yuta SHIMONISHI, Kariya-city (JP); Shuhei Yoshida, Kariya-city (JP); Hitoshi Onodera, Kariya-city (JP)

(21) Appl. No.: 18/893,039

(22) Filed: Sep. 23, 2024

Related U.S. Application Data
(63) Continuation of application No. PCT/JP2023/018333, filed on May 16, 2023.

(30) Foreign Application Priority Data
Nov. 1, 2022 (JP) 2022-175676

(51) Int. Cl. H01M 10/0562; H01M 4/02; H01M 4/04; H01M 4/134; H01M 4/38; H01M 10/44

(52) U.S. Cl. CPC H01M 10/0562; H01M 4/0445; H01M 4/134; H01M 4/382; H01M 10/446; H01M 2004/027; H01M 2300/0071

(57) ABSTRACT

A secondary battery includes a positive electrode, a negative electrode, an electrolyte layer, and a shut layer. The electrolyte layer is made of an electrolyte material having lithium ion conductivity. The shut layer contains a lithium ion conductive solid material having lithium ion conductivity. The electrolyte layer is interposed between the negative electrode and the shut layer. The shut layer is made of only a lithium ion conductive solid material or a mixture of the lithium ion conductive solid material. The lithium ion conductive solid material is at least one of a pyrochlore solid electrolyte, a NASICON solid electrolyte, and a perovskite solid electrolyte. The lithium ion conductive solid material has a larger decrease in lithium ion conductivity when in contact with lithium metal than the electrolyte material.

### CROSS REFERENCE TO RELATED APPLICATIONS

The present application is a continuation application of International Patent Application No. PCT/JP2023/018333 filed on May 16, 2023, which designated the U.S. and claims the benefit of priority from Japanese Patent Application No. 2022-175676 filed on Nov. 1, 2022. The entire disclosures of all of the above applications are incorporated herein by reference.

### TECHNICAL FIELD

The present disclosure relates to a secondary battery.

### BACKGROUND ART

As a secondary battery, a lithium ion battery is known, in which charge and discharge are performed by lithium ions moving between a positive electrode and a negative electrode. There is a concern that a short circuit occurs between the electrodes, in the lithium ion battery, when charge and discharge are repeated, since dendrites of lithium metal grow from the negative electrode and may reach the positive electrode.

### SUMMARY

A secondary battery of the present disclosure includes a positive electrode, a negative electrode, an electrolyte layer, and a shut layer. The positive electrode contains a positive electrode active material. The negative electrode contains a negative electrode active material. The electrolyte layer is provided adjacent to the negative electrode and is made of an electrolyte material having lithium ion conductivity. The shut layer is provided adjacent to the positive electrode and contains a lithium ion conductive solid material having lithium ion conductivity. The electrolyte layer is interposed between the negative electrode and the shut layer.

### BRIEF DESCRIPTION OF DRAWINGS

FIG. 1 is a cross-sectional view illustrating a configuration of a secondary battery according to a first embodiment.

FIG. 2 is a diagram illustrating a process of producing a pyrochlore solid electrolyte.

FIG. 3 is a diagram illustrating a crystal structure of a pyrochlore solid electrolyte.

FIG. 4 is a graph showing a temporal change in resistance when lithium metal is brought into contact with a lithium ion conductive solid material.

FIG. 5 is a graph showing a temporal change in rate of increase in resistance when lithium metal is brought into contact with a lithium ion conductive solid material.

FIG. 6 is a cross-sectional view illustrating an initial state configuration of a secondary battery according to a sixth embodiment.

FIG. 7 is a cross-sectional view illustrating a state of charge of the secondary battery according to the sixth embodiment.

FIG. 8 is a cross-sectional view illustrating an initial state configuration of a secondary battery according to a seventh embodiment.

FIG. 9 is a cross-sectional view illustrating a configuration of a secondary battery according to an eighth embodiment.

FIG. 10 is a table showing whether or not a short circuit has occurred in secondary batteries of Example 1 to 4 and Comparative Example.

### DETAILED DESCRIPTION

As a secondary battery, a lithium ion battery is known, in which charge and discharge are performed by lithium ions moving between a positive electrode and a negative electrode. There is a concern that a short circuit occurs between the electrodes, in the lithium ion battery, when charge and discharge are repeated, since dendrites of lithium metal grow from the negative electrode and may reach the positive electrode.

A shut layer is provided between an electrolyte layer and a positive electrode of a lithium ion battery. The shut layer contains a lithium ion conductive liquid that reacts with lithium metal to generate an electronic insulator. According to the secondary battery, when the dendrite grown from the negative electrode reaches the shut layer, an electronic insulator is generated and the growth of the dendrite is suppressed.

However, in the secondary battery, although the lithium ion conductive liquid of the shut layer is held by the porous membrane, it is difficult to completely hold the liquid. The lithium ion conductive liquid may leak and contact the negative electrode, due to expansion and contraction stress associated with charge and discharge of the secondary battery. If the lithium ion conductive liquid comes into contact with the negative electrode, an insulator is generated in the vicinity of the interface between the negative electrode and the electrolyte, which causes a decrease in battery performance due to an increase in resistance.

The present disclosure provides a secondary battery that can be stably used while suppressing a short circuit between electrodes.

A secondary battery of the present disclosure includes a positive electrode, a negative electrode, an electrolyte layer, and a shut layer. The positive electrode contains a positive electrode active material. The negative electrode contains a negative electrode active material. The electrolyte layer is provided adjacent to the negative electrode and is made of an electrolyte material having lithium ion conductivity. The shut layer is provided adjacent to the positive electrode and contains a lithium ion conductive solid material having lithium ion conductivity. The electrolyte layer is interposed between the negative electrode and the shut layer.

In a first aspect of the present disclosure, the electrolyte material is a solid electrolyte, an electrolyte solution, a polymer, or a mixture thereof. The shut layer is made of only a lithium ion conductive solid material or a mixture of the lithium ion conductive solid material and at least one of a solid electrolyte, an electrolytic solution, and a polymer. The lithium ion conductive solid material is at least one of a pyrochlore solid electrolyte, a NASICON solid electrolyte, and a perovskite solid electrolyte. The lithium ion conductive solid material has a larger decrease in lithium ion conductivity when in contact with lithium metal than the electrolyte material.

In a second aspect of the present disclosure, the lithium ion conductive solid material forms a non-conductor of lithium ions when in contact with lithium metal.

Accordingly, it is possible to provide a stably usable secondary battery while suppressing a short circuit between electrodes.

Hereinafter, embodiments for carrying out the present disclosure will be described with reference to the drawings. In each embodiment, the same reference numerals may be given to parts corresponding to matters described in a preceding embodiment, and overlapping explanations may be omitted. When only a part of the configuration is described in each embodiment, the previously described other embodiments can be applied to other parts of the configuration. A combination of parts is possible when it is explicitly stated that the combination is possible in each embodiment. A partial combination of the embodiments is also possible even if it is not explicitly stated that the partial combination is possible, unless there is a particular problem with the partial combination.

### First Embodiment

Hereinafter, a first embodiment will be described with reference to the drawings, in which the secondary battery of the present disclosure is applied to a lithium ion battery. The secondary battery 10 of the present embodiment is a lithium ion battery cell in which charging and discharging are performed by lithium ions moving between a negative electrode 12 and a positive electrode 14.

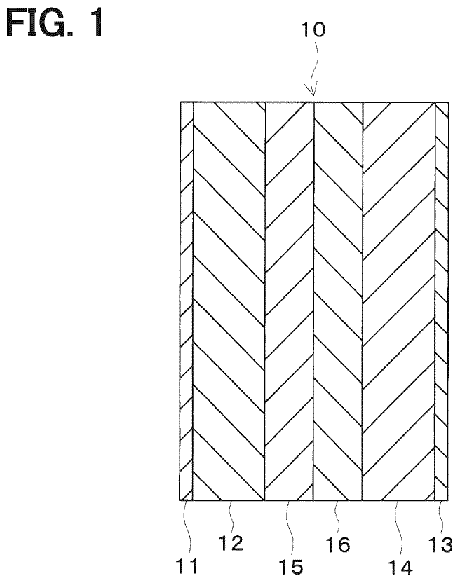

As shown in FIG. 1, the secondary battery 10 includes a negative electrode current collector 11, a negative electrode 12, a positive electrode current collector 13, a positive electrode 14, an electrolyte layer 15, and a shut layer 16. These layers of the negative electrode current collector 11, the negative electrode 12, the positive electrode current collector 13, the positive electrode 14, the electrolyte layer 15 and the shut layer 16 are stacked with each other.

The electrolyte layer 15 and the shut layer 16 are provided between the negative electrode 12 and the positive electrode 14. The electrolyte layer 15 is provided adjacent to the negative electrode 12, and the negative electrode 12 and the electrolyte layer 15 are in contact with each other. The shut layer 16 is provided adjacent to the positive electrode 14, and the positive electrode 14 and the shut layer 16 are in contact with each other. The negative electrode 12 and the positive electrode 14 are connected via the electrolyte layer 15 and the shut layer 16.

The negative electrode 12, the positive electrode 14, the electrolyte layer 15, and the shut layer 16 are provided between the negative electrode current collector 11 and the positive electrode current collector 13. The negative electrode current collector 11 and the negative electrode 12 are in contact with each other, and the positive electrode current collector 13 and the positive electrode 14 are in contact with each other. The negative electrode current collector 11 and the positive electrode current collector 13 are connected to each other via a stacked body including the negative electrode 12, the positive electrode 14, the electrolyte layer 15, and the shut layer 16.

A predetermined material that can be used as a current collector for a lithium ion battery is used for the negative electrode current collector 11 and the positive electrode current collector 13. In the present embodiment, Cu is used as the negative electrode current collector 11, and Al is used as the positive electrode current collector 13.

The negative electrode current collector 11 and the positive electrode current collector 13 may have a predetermined shape, for example, a foil shape or a plate shape. In the present embodiment, the foil-shaped current collector 11, 13 is used. The current collector 11, 13 may have a three-dimensional structure, for example, a structure provided with protrusions or a mesh structure.

The negative electrode 12 contains a negative electrode active material. As the negative electrode active material, a predetermined material that can be used as a negative electrode active material for a lithium ion battery is used, for example, lithium metal, graphite, Si, or a mixture thereof. In the present embodiment, lithium metal is used as the negative electrode active material.

The positive electrode 14 contains a positive electrode active material. As the positive electrode active material, a predetermined material that can be used as a positive electrode active material for a lithium ion battery is used.

As the positive electrode active material, for example, a layered active material, a spinel active material, or an olivine active material can be used. As the layered active material, for example, a ternary positive electrode material such as LiCoO₂ (LCO), LiNiO₂ (LNO), LiNi_{0.8}Co_{0.15}Al_{0.05}O₂ (NCA), or LiNi_{0.8}Co_{0.1}Mn_{0.1}O₂ (NCM811) can be used. As the spinel type active material, for example, LiMn₂O₄ or LiNi_{0.5}Mn_{1.5}O₄ can be used. As the olivine active material, for example, LiMn_{0.8}Fe_{0.2}PO₄ (LMFP) or LiFePO₄ (LFP) can be used.

Among the positive electrode active materials described above, the olivine-type active material generally has the lowest ion conductivity. Therefore, when the olivine-type active material is used as the positive electrode active material of the secondary battery 10, dendrites are likely to be generated from the negative electrode 12 during charging.

The positive electrode 14 may contain at least one of an electrolytic solution and a polymer in addition to the positive electrode active material. As the electrolytic solution, for example, ethylene carbonate or the like can be used. The electrolytic solution may be an ionic liquid. As the polymer, for example, polyethylene oxide can be used.

The electrolyte layer 15 is provided so as to be in direct contact with the negative electrode 12. The electrolyte layer 15 is made of an electrolyte material having lithium ion conductivity. The electrolyte layer 15 has a function of conducting lithium ions between the negative electrode 12 and the positive electrode 14 and securing insulation between the negative electrode 12 and the positive electrode 14.

In principle, the electrolyte material used for the electrolyte layer 15 does not decrease in lithium ion conductivity even when it comes into contact with lithium metal. However, this does not exclude the possibility that when the electrolyte material comes into contact with lithium metal, the lithium ion conductivity of the electrolyte material is slightly changed due to factors such as the presence of surface impurities and conformance of the interface. Even if the electrolyte material comes into contact with the lithium metal and the lithium ion conductivity is the lowest, the lithium ion conductivity is only reduced by a factor of several before coming into contact with the lithium metal, and the resistance is only increased by a factor of several or less.

As the electrolyte material of the electrolyte layer 15, a solid electrolyte, an electrolytic solution, a polymer, or a mixture thereof can be used. Among these electrolyte materials, the electrolyte solution generally has the highest lithium ion conductivity, and the polymer and the solid electrolyte have lower lithium ion conductivity in this order. In general, the usable temperature range is the highest for the solid electrolyte, and the usable temperature range becomes lower for the polymer and the electrolyte in this order.

In general, the safety in a case where a short circuit occurs in the secondary battery 10 is the highest in the solid electrolyte, and becomes lower in the order of the polymer and the electrolytic solution. Since a short circuit of the secondary battery 10 occurs due to a non-uniform reaction caused by unevenness in current density, a short circuit is more likely to occur as the contact between the negative electrode active material and the electrolyte material becomes worse. Therefore, in general, a short circuit is most likely to occur in the solid electrolyte, and a short circuit is less likely to occur in the polymer and the electrolytic solution in this order.

In the present embodiment, a solid electrolyte is used as the electrolyte material of the electrolyte layer 15. As the solid electrolyte, for example, an oxide solid electrolyte or a sulfide solid electrolyte can be used. In the present embodiment, LLZO (Li₇La₃Zr₂O₁₂), which is an oxide-based solid electrolyte, is used as the electrolyte layer 15. The electrolyte layer 15 may contain at least one of an electrolyte solution and a polymer in addition to the solid electrolyte. As the electrolytic solution, for example, ethylene carbonate or the like can be used. The electrolytic solution may be an ionic liquid. As the polymer, for example, polyethylene oxide can be used.

The shut layer 16 and the negative electrode 12 are provided so as not to be in direct contact with each other, and the electrolyte layer 15 is interposed between the shut layer 16 and the negative electrode 12. The shut layer 16 contains a lithium ion conductive solid material that comes into contact with lithium metal to reduce the lithium ion conductivity. The lithium ion conductive solid material is an ion conductor having lithium ion conductivity. The lithium ion conductive solid material of the shut layer 16 can be provided by being applied to the surface of the positive electrode 14 or the electrolyte layer 15 formed in a sheet shape, or can be provided by being applied to the surface of a particulate positive electrode active material.

The lithium ion conductive solid material has a larger decrease in lithium ion conductivity when in contact with lithium metal than the electrolyte material used for the electrolyte layer 15. As described above, even when the electrolyte material of the electrolyte layer 15 comes into contact with lithium metal, the lithium ion conductivity hardly decreases. On the other hand, when the lithium ion conductive solid material comes into contact with lithium metal, at least the lithium ion conductivity decreases to 1/100 or less and the resistance increases to 100 times or more as compared with before coming into contact with lithium metal.

That is, when the lithium ion conductive solid material comes into contact with lithium metal, the ion conductivity decreases by two or more orders of magnitude, and the resistance increases by two or more orders of magnitude. As described above, when the lithium ion conductive solid material comes into contact with the lithium metal, the lithium ion conductivity decreases by two or more orders of magnitude, and the resistance increases by two or more orders of magnitude, the current value that can be supplied becomes 1/100 or less, and it becomes difficult to function as a battery. Note that the electrolyte layer 15 is interposed between the shut layer 16 and the negative electrode 12. In a normal state, the lithium metal does not come into contact with the shut layer 16, and the lithium ion conductivity of the lithium ion conductive solid material does not decrease.

The shut layer 16 may include at least one of an electrolytic solution and a polymer in addition to the lithium ion conductive solid material. As the electrolytic solution, for example, ethylene carbonate or the like can be used. The electrolytic solution may be an ionic liquid. As the polymer, for example, polyethylene oxide can be used.

The thickness of the shut layer 16 is preferably as thin as possible from the viewpoint of reducing the cell resistance. In the present embodiment, the thickness of the shut layer 16 is 10 μm or less. If the thickness of the shut layer 16 is too small, it is difficult to uniformly form the shut layer 16, and there is a possibility that a region where the shut layer 16 does not exist is formed. Therefore, the thickness of the shut layer 16 is preferably within a range of 2 to 3 μm or more.

When the Li metal is non-uniformly deposited on the negative electrode 12, dendrites are likely to grow from the negative electrode 12. When the dendrite reaches the shut layer 16 from the negative electrode 12 through the electrolyte layer 15, the lithium ion conductivity of the lithium ion conductive solid material decreases at a portion of the shut layer 16 in contact with the lithium metal, and the resistance increases to be insulated. That is, when the lithium ion conductive solid material is brought into contact with lithium metal, the ionic conductivity is greatly reduced to form a non-conductor of lithium ion. The “non-conductor of lithium ion” means a state in which the lithium ion conductive solid material is in contact with lithium metal and the ion conductivity is reduced to 1/100 or less.

In the shut layer 16, the lithium precipitation reaction stops in the vicinity of the contact portion with the lithium metal, and the growth of the dendrite stops. That is, the shut layer 16 has a shutdown function of limiting the movement of lithium ions between the negative electrode 12 and the positive electrode 14 to stop the function of the secondary battery 10, and suppressing a short circuit between the negative electrode 12 and the positive electrode 14.

At least one of a pyrochlore type oxide-based solid electrolyte, a NASICON type oxide-based solid electrolyte, and a perovskite type oxide-based solid electrolyte can be used as the lithium ion conductive solid material in which the lithium ion conductivity is reduced by contact with lithium metal. As the pyrochlore type oxide solid electrolyte, for example, Li_{1.25}La_{0.58}Nb₂O₆F can be used. As the NASICON type oxide solid electrolyte, for example, Li_{1.4}Al_{0.4}Ti_{1.6}(PO₄)₃ (LATP) can be used. As the perovskite-type oxide solid electrolyte, for example, La_{0.57}Li_{0.29}TiO₃ (LLTO) can be used.

FIG. 4 shows a temporal change in the resistance value (Ω) when lithium metal is brought into contact with Li_{1.25}La_{0.58}Nb₂O₆F, Li_{1.4}Al_{0.4}Ti_{1.6}(PO₄)₃, and La_{0.57}Li_{0.29}TiO₃.

As shown in FIG. 4, the resistance value before contact with lithium metal is about 80 to 200 Ω, Li_{1.25}La_{0.58}Nb₂O₆F is the lowest, La_{0.57}Li_{0.29}TiO₃ is the second lowest, and Li_{1.4}Al_{0.4}Ti_{1.6}(PO₄)₃ is the highest.

Then, when lithium metal is brought into contact, the resistance values of Li_{1.25}La_{0.58}Nb₂O₆F, Li_{1.4}Al_{0.4}Ti_{1.6}(PO₄)₃, and La_{0.57}Li_{0.29}TiO₃ gradually increase, and become constant after reaching about 100,000Ω. The resistance value after the lithium metal is brought into contact with Li_{1.25}La_{0.58}Nb₂O₆F, Li_{1.4}Al_{0.4}Ti_{1.6}(PO₄)₃, and La_{0.57}Li_{0.29}TiO₃ is increased to about 500 times or more the resistance value before the lithium metal is brought into contact. The rate of increase in the resistance value is the fastest for Li_{1.25}La_{0.58}Nb₂O₆F, the second fastest for Li_{1.4}Al_{0.4}Ti_{1.6}(PO₄)₃, and the slowest for La_{0.57}Li_{0.29}TiO₃.

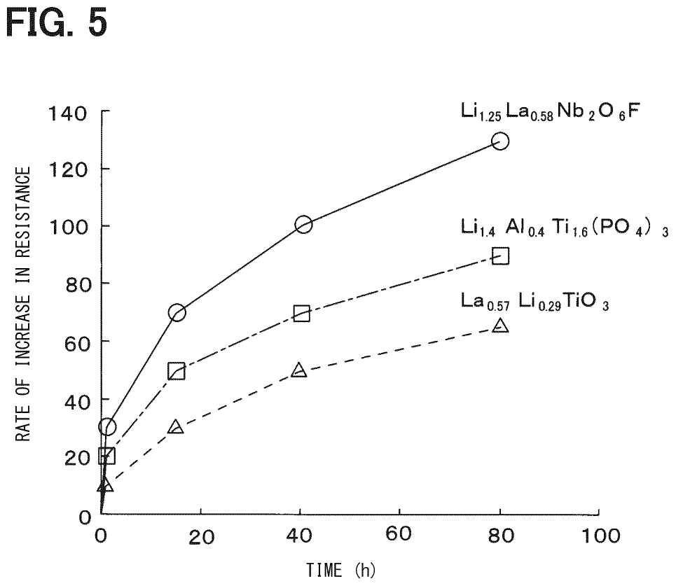

FIG. 5 shows a temporal change in the rate of increase in resistance when lithium metal is brought into contact with Li_{1.25}La_{0.58}Nb₂O₆F, Li_{1.4}Al_{0.4}Ti_{1.6}(PO₄)₃, and La_{0.57}Li_{0.29}TiO₃.

As shown in FIG. 5, the rate of increase in resistance when lithium metal is brought into contact is the largest for Li_{1.25}La_{0.58}Nb₂O₆F, the second largest for Li_{1.4}Al_{0.4}Ti_{1.6}(PO₄)₃, and the smallest for La_{0.57}Li_{0.29}TiO₃.

That is, among the lithium ion conductive solid materials described above, the pyrochlore solid electrolyte has the fastest rate of increase in resistance and the largest rate of increase in resistance when in contact with lithium metal. Therefore, when the pyrochlore solid electrolyte is used as the lithium ion conductive solid material included in the shut layer 16, the time until shutdown is the shortest, and safety is improved.

The pyrochlore solid electrolyte has the lowest resistance value before coming into contact with lithium metal (that is, in a normal state,). For this reason, among the lithium ion conductive solid materials described above, the pyrochlore type solid electrolyte has the highest ion conductivity in a normal state, and the input/output characteristics of the secondary battery 10 are excellent.

The pyrochlore solid electrolyte is excellent in safety and has higher ion conductivity than other oxide-based solid electrolytes. Furthermore, the pyrochlore solid electrolyte has characteristics that, when containing a specific type of cation, the resistance is increased by contact with lithium metal and the ionic conductivity is reduced.

The lithium ion conductive solid material of the present embodiment is an oxide-based solid electrolyte having a pyrochlore structure represented by the composition formula “Aa_{2-α}Ab_{(1+α)/3}B₂O_{7-β}X_{β}”. In the above composition formula, O is an oxygen atom, and Aa, Ab, B, and X represent elements or groups. Aa, Ab and B are different types of cations, and O and X are different types of anions. In the above composition formula, 0.6<α<2.0, and 0<β≤1 are satisfied. When α changes, the composition ratio of Aa and Ab changes. When β changes, the composition ratio of O and X changes.

Aa is an alkali metal. As the alkali metal represented by Aa, any one of Li, Na, and K can be used. In the present embodiment, Li is used as Aa. The composition ratio (2−α) of Aa is within the range of 0<(2−α)<1.4.

Ab contains at least a lanthanoid. As the lanthanoid represented by Ab, at least one of La, Ce, Nd, and Sm can be used. In the present embodiment, La is used as Ab. The composition ratio (1+α)/3 of Ab is within the range of 0.53<(1+α)/3<1.

A basic structure of Ab consists of the lanthanoid, and a part of the lanthanoid constituting Ab may be substituted with an alkaline earth metal (such as Ca, Mg, Sr, or the like). In the shut layer 16 of the present embodiment, it is considered that the ion conductivity is improved when defects are generated in the crystal structure since the lanthanoid is included in the pyrochlore structure in which 0.6<α<2.0 and 0<β≤1 are satisfied.

In the pyrochlore solid electrolyte of the present embodiment, the A cation in the general pyrochlore composition formula “A₂B₂O₇” is a composite cation using lithium metal and lanthanoid. This is considered to contribute to the improvement of the ionic conductivity of the pyrochlore solid electrolyte.

B is a cationic metal different from Aa and Ab, and is a metal selected from a group 4 element, a group 5 element, or a group 15 element. B constitutes an octahedron surrounded by six O atoms in a crystal. At least one of Nb, V, Sb, Bi, Ta, Zr, Ti, and Hf can be used as the group 4 element, the group 5 element, or the group 15 element represented by B. In the pyrochlore solid electrolyte using at least one of Nb, V, Sb, Bi, Ta, Zr, Ti, and Hf as the B cation, lithium ion conductivity decreases due to contact with metallic lithium. This point will be described in detail later.

X is an anion that can be substituted with an O atom constituting the pyrochlore structure. X is different from an O atom in electronegativity and polarizability. As the anion represented by X, at least one of F, S, Cl, and OH can be used. The composition ratio β of X is within the range of 0<β≤1, and at least a part of O atoms constituting the pyrochlore structure is substituted with X. In the present embodiment, F is used as X.

The pyrochlore solid electrolyte of the present embodiment has a defect structure in which lattice defects are included in the crystal by replacing a part of O atoms constituting the pyrochlore structure with anions having electronegativity and polarizability different from those of the O atoms. The pyrochlore solid electrolyte of the present embodiment is considered to have improved ion conductivity because the pyrochlore structure includes the defect structure.

In the pyrochlore solid electrolyte of the present embodiment, Aa and Ab are partially deficient as a defect structure. The composition formula of the general pyrochlore structure is “A₂B₂O₇”, and a composition ratio of the A cation is 2. In contrast, in the pyrochlore solid electrolyte of the present embodiment, the composition ratios of Aa and Ab are “2−α” and “(1+α)/3”, respectively, and 0.6 <α<2.0 is satisfied, so that the total composition ratio of Aa and Ab is less than 2. That is, in the crystal structure of the pyrochlore solid electrolyte of the present embodiment, at least one of Aa and Ab is partially deficient. A composition ratio corresponding to the deficient portion of Aa and Ab is (2α−1)/3.

In addition to the deviation of the composition ratio, the defect structure can also be formed by making a sum of valences of the cations consisting of Aa, Ab and B and the anions consisting of O and X negative in the above composition formula.

In addition, the pyrochlore solid electrolyte of the present embodiment is a composite anionic compound in which plural anions such as O and X are included in the pyrochlore structure. The anion represented by X is included in the BO6 coordination octahedron structure. Therefore, the alkali metal of Aa can be positioned in the central portion of the space with the BO6 coordination octahedron without being shifted to the BO6 coordination octahedron. Therefore, it is considered that the pyrochlore solid electrolyte of the present embodiment has high ion conduction when used by applying an electric field such as a battery.

In addition, since α and β in the above composition formula affect the lattice defects and the ion conductivity, it is desirable to set α and β in an appropriate range. When the values of α and β are large, a defect concentration in the crystal lattice increases, but when the values exceed a certain amount, the concentration of the alkali metal represented by Aa decreases and the ion conductivity decreases. Therefore, it is desirable to control α within a range of 0.6<α<2.0 and β within a range of 0<β≤1.

Here, a decrease in lithium ion conductivity of the pyrochlore solid electrolyte of the present embodiment will be described. As described above, the pyrochlore solid electrolyte in which at least one of Nb, V, Sb, Bi, Ta, Zr, Ti, and Hf is used as the B cation has characteristics that the lithium ion conductivity is lowered by contact with metallic lithium.

In the pyrochlore type solid electrolyte in which Nb is used as the B cation, Nb is chemically reduced when being brought into contact with lithium metal, so that the resistance is increased and the ion conductivity decreases. When the pyrochlore solid electrolyte in which the B cation is Nb is brought into contact with lithium metal for several tens of minutes, the bulk conductivity decreases from 3.3×10⁻³ S/cm to 6.3×10⁻⁴ S/cm, and the grain boundary conductivity decreases from 2.0×10⁻³ S/cm to 6.4×10⁻⁵ S/cm.

In addition, it has been confirmed that also in the pyrochlore type solid electrolyte using Ta or Zr as the B cation, when the pyrochlore type solid electrolyte is brought into contact with lithium metal, Ta or Zr is chemically reduced, so that the resistance is increased and the ion conductivity is reduced.

The band gap Eg of the pyrochlore solid electrolyte can be used as an index of the difficulty of chemical reduction of B cations when in contact with lithium metal, in other words, the difficulty of reduction in ion conductivity. As the band gap Eg is smaller, the B cation is more likely to be reduced, and the ion conductivity is more likely to decrease. It is considered that the B cation contained in the pyrochlore solid electrolyte having a band gap smaller than that of the pyrochlore solid electrolyte containing at least Nb, Ta, and Zr is reduced when the B cation comes into contact with lithium metal. That is, it is considered that the ionic conductivity of the pyrochlore type solid electrolyte having a band gap smaller than that of the pyrochlore type solid electrolyte containing Nb, Ta, and Zr as B cations is reduced by contact with lithium metal.

The band gap Eg of the pyrochlore solid electrolyte calculated by the first principle calculation is 3.293 eV for Li₂Nb₂O₆F, 4.163 eV for Li₂Ta₂O₆F, 3.401 eV for Li₂Zr₂O₆F, 3.429 eV for Li₂Ti₂O₆F, 4.082 eV for Li₂Hf₂O₆F, 1.415 eV for Li₂V₂O₆F, 1.469 eV for Li₂Sb₂O₆F, and 0.789 eV for Li₂Bi₂O₆F.

Li₂Nb₂O₆F, Li₂Ta₂O₆F, and Li₂Zr₂O₆F are pyrochlore solid electrolytes containing Nb, Ta, and Zr as B cations, respectively. Li₂Ti₂O₆F, Li₂Hf₂O₆F, Li₂V₂O₆F, Li₂Sb₂O₆F, and Li₂Bi₂O₆F are pyrochlore solid electrolytes having a smaller band gap than the pyrochlore solid electrolyte containing Nb, Ta, and Zr as B cations. That is, in the pyrochlore solid electrolyte using at least one of Nb, V, Sb, Bi, Ta, Zr, Ti, and Hf as the B cation, the lithium ion conductivity decreases when the pyrochlore solid electrolyte is in contact with metallic lithium.

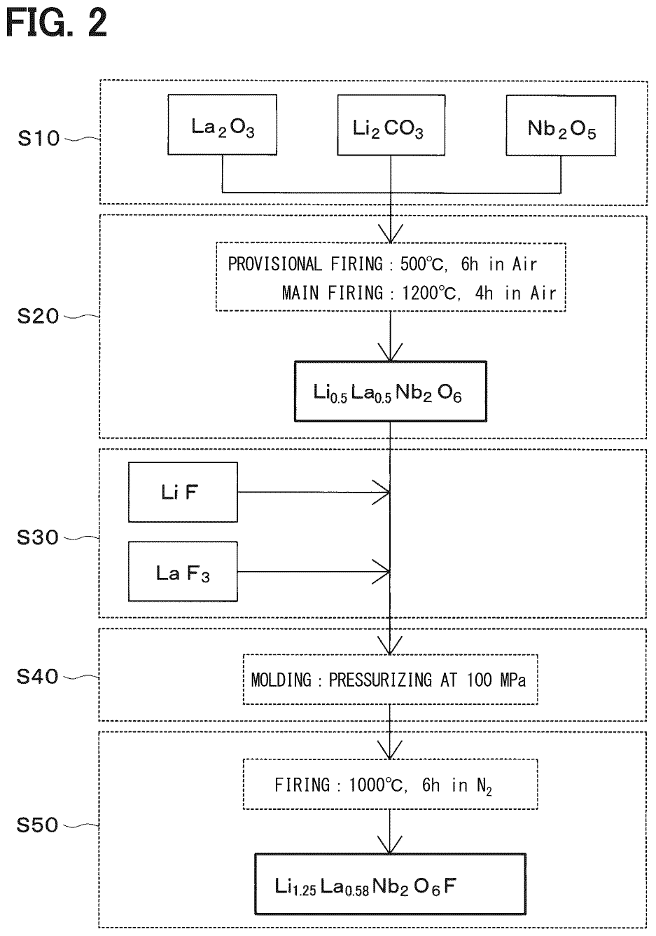

Next, the pyrochlore solid electrolyte of the present embodiment will be described with reference to FIG. 2. In the method of producing the pyrochlore solid electrolyte, a first mixing process S10, a first firing process S20, a second mixing process S30, a molding process S40, and a second firing process S50 are sequentially performed.

### First Mixing Process

First, a lanthanum source, a lithium source, and a niobium source are prepared as raw materials, and a first mixing process S10 of mixing them is performed. As the lanthanum source, the lithium source, and the niobium source, a metal oxide, a metal carbonate, or the like can be used. In the present embodiment, La₂O₃ is used as the lanthanum source, Li₂CO₃ is used as the lithium source, and Nb₂O₅ is used as the niobium source. In the first mixing process, La₂O₃, Li₂CO₃, and Nb₂O₅ are mixed at a predetermined ratio.

### First Firing Process

Next, the first firing process S20 of firing the mixture of La₂O₃, Li₂CO₃, and Nb₂O₅ is performed. In the first firing process S20, two stages of firing are performed. In a first stage, a provisional firing is performed by heating the mixture in air at 500° C. for 6 hours. By the provisional firing, moisture and the like are removed from the mixture, and the reactivity can be increased. Subsequent to the provisional firing, a main firing is performed, in which the mixture is heated in air at 1200° C. for 4 hours. Accordingly, Li_{0.5}La_{0.5}Nb₂O₆ which is a precursor of a target product is obtained.

### Second Mixing Process

Next, a fluorine source is prepared as a raw material, and the fluorine source is mixed with Li_{0.5}La_{0.5}Nb₂O₆ being the precursor in the second mixing process S30. As the fluorine source, a metal fluoride can be used. In the present embodiment, LiF and LaF₃ are used as fluorine sources. LiF is a fluorine source and a lithium source, and LaF₃ is a fluorine source and a lanthanum source. In the second mixing process S30, LiF and LaF₃ are mixed with Li_{0.5}La_{0.5}Nb₂O₆ at a predetermined ratio to obtain a mixed powder.

### Molding Process

Next, the molding process S40 is performed in which the mixed powder of Li_{0.5}La_{0.5}Nb₂O₆, LiF, and LaF₃ is processed into a pellet shape and is pressurized at 100 MPa. Accordingly, the mixture of Li_{0.5}La_{0.5}Nb₂O₆, LiF, and LaF₃ is formed into a pellet shape.

### Second Firing Process

Next, the second firing process S50 of firing the mixture of Li_{0.5}La_{0.5}Nb₂O₆, LiF, and LaF₃ is performed. In the second firing process S50, firing is performed by heating the mixture of Li_{0.5}La_{0.5}Nb₂O₆, LiF, and LaF₃ at 1000° C. for 6 hours in a nitrogen atmosphere.

Through the above processes, a crystal having a pyrochlore structure represented by the composition formula “Li_{1.25}La_{0.58}Nb₂O₆F” can be obtained. This time, the crystal obtained in the second firing process S50 is in the form of a pellet. The relative density of the solid electrolyte sintered body in the form of pellet is 78%.

A crystal having a pyrochlore structure represented by the composition formula “Li_{2-α}La_{(1+α)/3}Nb₂O_{7-β}F_{β}” can be obtained by changing the mixing ratio of La₂O₃, Li³CO₃, and Nb₃O₅ and the mixing ratio of LiF and LaF₃ in the manufacturing process.

In the composition formula, α can be adjusted by changing the mixing ratio of La₂O₃, Li₂CO₃, and Nb₂O₅, and β can be adjusted by changing the mixing ratio of LiF and LaF₃. When firing is performed, a part of the materials is sublimated. Therefore, α and β can also be adjusted by changing firing conditions, firing furnace atmosphere, and firing furnace size in the first firing process and the second firing process.

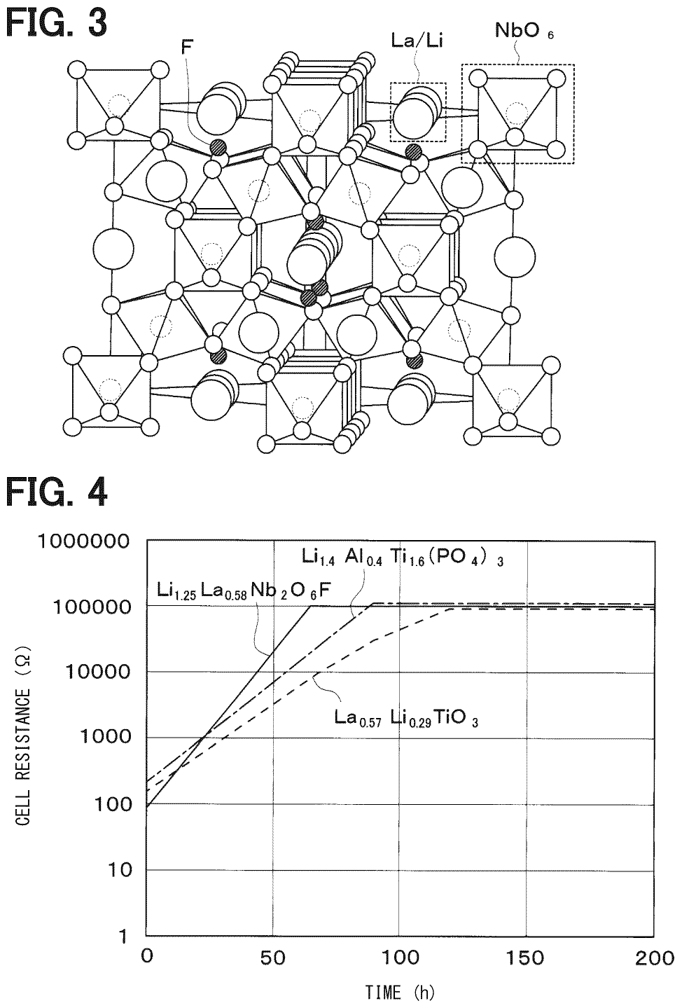

Next, the crystal structure of the pyrochlore solid electrolyte will be described with reference to FIG. 3. FIG. 3 shows a crystal structure obtained by analyzing a pyrochlore solid electrolyte by radiation light. In the radiation light analysis, the crystal structure was obtained by performing Rietveld analysis using measurement data by X-ray diffraction (XRD).

As shown in FIG. 3, the pyrochlore solid electrolyte has a crystal structure in which an octahedral three-dimensional network composed of NbO₆ is formed. In NbO₆, O is arranged at each vertex with Nb as the center, and each vertex is shared with the adjacent NbO₆. In the three-dimensional network composed of NbO₆, a hexagonal tunnel structure is formed, in which cations composed of La/Li and anions composed of F are arranged.

The secondary battery 10 of the present embodiment has the shut layer 16 containing a lithium ion conductive solid material whose lithium ion conductivity is reduced when coming into contact with lithium metal. As a result, even if dendrites grow from the negative electrode 12, the lithium ion conductivity decreases in the shut layer 16. The resistance increases to be insulated, and a non-conductor of lithium ion is formed. As a result, in the shut layer 16, growth of dendrites can be stopped, and a short circuit between the negative electrode 12 and the positive electrode 14 can be suppressed.

The lithium ion conductive solid material is a solid and is stably held inside the secondary battery 10. For example, even if the secondary battery 10 expands and contracts with charging and discharging, the lithium ion conductive solid material of the shut layer 16 does not come into direct contact with the negative electrode 12. Therefore, unless dendrites grow from the negative electrode 12 and reach the shut layer 16, the lithium ion conductivity of the lithium ion conductive solid material does not decrease, and the secondary battery 10 can be stably used.

In addition, by using the pyrochlore solid electrolyte as the lithium ion conductive solid material, the secondary battery 10 can be shut down in a short time by contact with lithium metal. Therefore, the safety of the secondary battery 10 can be improved.

The pyrochlore solid electrolyte of the present embodiment is a material having higher ion conductivity than an oxide-based solid electrolyte conventionally known as a solid electrolyte for a secondary battery. Therefore, in the configuration in which the shut layer 16 is provided in the secondary battery 10, it is possible to avoid a decrease in ion conductivity while suppressing a short circuit of the secondary battery 10.

When lithium metal is used as the negative electrode active material of the negative electrode 12, a short circuit of the secondary battery 10 is likely to occur. In the secondary battery 10 using lithium metal as such a negative electrode active material, the short circuit of the secondary battery 10 can be effectively suppressed by providing the shut layer 16.

When an olivine-type active material is used as the positive electrode active material of the positive electrode 14, a short circuit of the secondary battery 10 is likely to occur. In the secondary battery 10 using the olivine-type active material as the positive electrode active material, the short circuit of the secondary battery 10 can be effectively suppressed by providing the shut layer 16.

In the present embodiment, a solid electrolyte is used for the electrolyte layer 15. A solid electrolyte is an electrolyte material that has high safety but is likely to cause a short circuit. In the secondary battery 10 using such a solid electrolyte, the short circuit of the secondary battery 10 can be effectively suppressed by providing the shut layer 16.

### Second Embodiment

The following describes a second embodiment of the present disclosure. Hereinafter, only portions different from the first embodiment will be described.

The positive electrode 14 of the second embodiment contains, in addition to the positive electrode active material, the same lithium ion conductive solid material as the lithium ion conductive solid material used in the shut layer 16. Also in the secondary battery 10 of the second embodiment having such a configuration, the same effects as those of the first embodiment can be obtained. In addition, by providing the positive electrode 14 with a lithium ion conductive solid material, the ion conductivity of the positive electrode 14 can be improved.

### Third Embodiment

The following describes a third embodiment of the present disclosure. Hereinafter, only portions different from the above embodiments will be described.

The shut layer 16 of the third embodiment contains, in addition to the lithium ion conductive solid material, the same solid electrolyte (for example, LLZO) as the solid electrolyte used in the electrolyte layer 15. Also in the secondary battery 10 of the third embodiment having such a configuration, the same effects as those of the first embodiment can be obtained.

### Fourth Embodiment

Next, a fourth embodiment of the present disclosure is described. Hereinafter, only portions different from the above embodiments will be described.

The positive electrode 14 of the fourth embodiment contains, in addition to the positive electrode active material, the same lithium ion conductive solid material as the lithium ion conductive solid material used in the shut layer 16. In addition to the lithium ion conductive solid material, the shut layer 16 of the fourth embodiment contains the same solid electrolyte (for example, LLZO) as the solid electrolyte used in the electrolyte layer 15. Also in the secondary battery 10 of the fourth embodiment having such a configuration, the same effects as those of the first embodiment can be obtained.

### Fifth Embodiment

Next, a fifth embodiment of the present disclosure is described. Hereinafter, only portions different from the above embodiments will be described.

In the electrolyte layer 15 of the fifth embodiment, not a solid electrolyte but an electrolyte solution and a separator are provided. The separator has a pore structure, and has a function of separating the negative electrode 12 and the positive electrode 14 and allowing ions to pass therethrough. As the separator, for example, a porous body can be used. As the electrolytic solution, for example, ethylene carbonate or the like can be used. The lithium ion conductive solid material of the shut layer 16 can be provided by being applied to the surface of the positive electrode 14 or the separator formed in a sheet shape, or can be provided by being applied to the surface of a particulate positive electrode active material.

Also in the secondary battery 10 of the fifth embodiment having such a configuration, the same effects as those of the first embodiment can be obtained. In addition, by using an electrolytic solution for the electrolyte layer 15, occurrence of a short circuit can be suppressed as compared with a case where a solid electrolyte is used.

### Sixth Embodiment

Next, a sixth embodiment of the present disclosure is described. Hereinafter, only portions different from the above embodiments will be described.

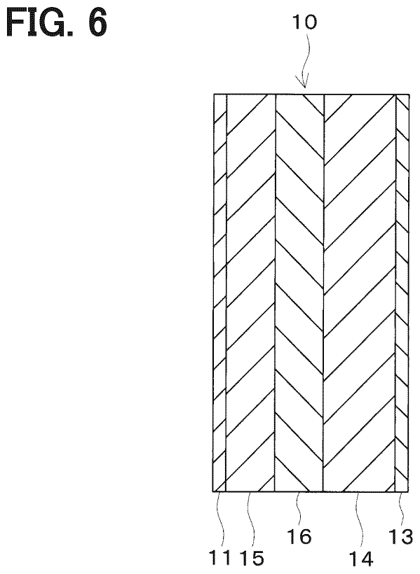

As shown in FIG. 6, in the initial state, the secondary battery 10 of the sixth embodiment has a negative electrode current collector 11, an electrolyte layer 15, a shut layer 16, a positive electrode 14, and a positive electrode current collector 13. That is, the secondary battery 10 of the sixth embodiment is configured as an anode-free battery in which the negative electrode 12 is not formed between the negative electrode current collector 11 and the electrolyte layer 15 in the initial state. The initial state is a state in which the components of the secondary battery 10 are assembled, and is a state in which the secondary battery 10 is not charged.

In the secondary battery 10 of the sixth embodiment, a solid electrolyte (for example, LLZO) is used as the electrolyte layer 15. In the initial state, the negative electrode current collector 11 and the electrolyte layer 15 are arranged adjacent to each other.

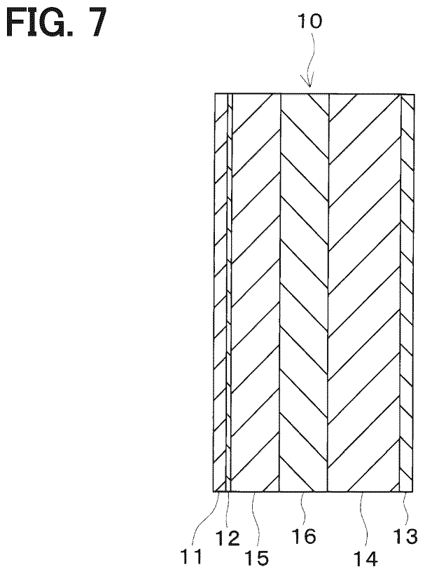

As shown in FIG. 7, the negative electrode 12 is formed in the secondary battery 10 by charging. When the secondary battery 10 is charged, lithium ions move from the positive electrode 14 to the negative electrode current collector 11, lithium metal is deposited on the negative electrode current collector 11 by a dissolution and deposition reaction, and the negative electrode 12 is formed by the lithium metal. The lithium metal formed on the negative electrode current collector 11 serves as a negative electrode active material.

The negative electrode 12 is formed between the negative electrode current collector 11 and the shut layer 16. In the sixth embodiment, the negative electrode 12 is formed between the negative electrode current collector 11 and the electrolyte layer 15, and is formed at the interface between the negative electrode current collector 11 and the electrolyte layer 15. The negative electrode 12 is formed so as to be in contact with the negative electrode current collector 11, and can exchange electrons with the negative electrode current collector 11. The lithium metal constituting the negative electrode 12 becomes lithium ions during discharge and moves to the positive electrode 14.

Also in the secondary battery 10 of the sixth embodiment having the above-described configuration, the same effects as those of the first embodiment can be obtained.

In the secondary battery 10 of the sixth embodiment, a coating layer that promotes the dissolution and deposition reaction of lithium metal may be provided on the surface of the negative electrode current collector 11 adjacent to the electrolyte layer 15. By the coating layer, the dissolution and deposition reaction of lithium metal can be made uniform, and the deposition of lithium metal can be promoted. As such a coating layer, an alloy material or a carbon material can be used.

### Seventh Embodiment

Next, a seventh embodiment of the present disclosure is described. Hereinafter, only portions different from the above embodiments will be described.

The secondary battery 10 of the seventh embodiment is configured as an anode-free battery similarly to the sixth embodiment. In the secondary battery 10 of the seventh embodiment, a solid electrolyte (for example, LLZO) is used as the electrolyte layer 15.

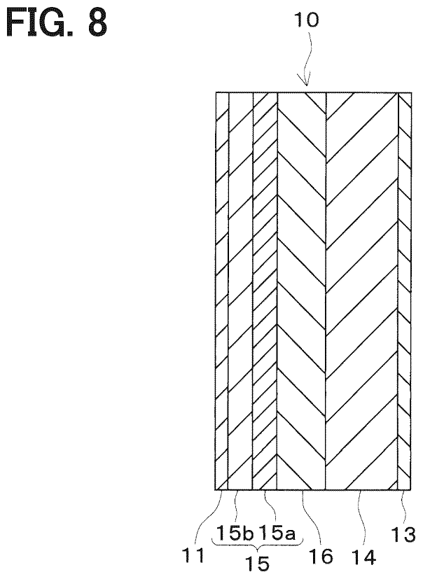

As shown in FIG. 8, in the secondary battery 10 of the seventh embodiment, the electrolyte layer 15 includes a dense layer 15a and a porous layer 15b. The dense layer 15a is provided adjacent to the positive electrode current collector 13 and is in contact with the shut layer 16. The porous layer 15b is provided adjacent to the negative electrode current collector 11 and is in contact with the negative electrode current collector 11.

The dense layer 15a and the porous layer 15b are made of the same solid electrolyte and have different densities. The dense layer 15a has a dense structure in which no hole is formed. The dense layer 15a can ensure insulation between the negative electrode 12 and the positive electrode 14. The porous layer 15b has a porous structure in which a large number of pores are formed, and has a density lower than that of the dense layer 15a.

The porous layer 15b has a predetermined shape, for example, a porous structure in which a large number of pores are regularly formed or a porous structure in which a large number of pores are irregularly formed. The porous layer 15b having a regular porous structure can be formed using, for example, a 3D printer. The porous layer 15b having an irregular porous structure can be produced, for example, by heating and removing a pore former mixed with a solid electrolyte.

When the secondary battery 10 is charged, lithium ions move from the positive electrode 14 to the negative electrode current collector 11, and lithium metal is deposited on the negative electrode current collector 11 by a dissolution and deposition reaction, thereby forming the negative electrode 12.

The negative electrode 12 is formed between the negative electrode current collector 11 and the shut layer 16. In the seventh embodiment, the negative electrode 12 is formed inside the hole of the porous layer 15b in a state of being in contact with the negative electrode current collector 11. Therefore, the negative electrode 12 is formed between the negative electrode current collector 11 and the dense layer 15a of the electrolyte layer 15. The negative electrode 12 formed in the porous layer 15b is in contact with the negative electrode current collector 11, and electrons can be exchanged with the negative electrode current collector 11.

Also in the secondary battery 10 of the seventh embodiment having the above configuration, the same effects as those of the first embodiment can be obtained.

When the negative electrode 12 is formed at the interface between the negative electrode current collector 11 and the electrolyte layer 15, the thickness of the secondary battery 10 is increased by the increase in the thickness of the negative electrode 12 during charging, and the thickness of the secondary battery 10 is decreased by the decrease in the thickness of the negative electrode 12 during discharging. In contrast, in the secondary battery 10 of the seventh embodiment, lithium metal is deposited inside the pores of the porous layer 15b of the electrolyte layer 15 to form the negative electrode 12. Therefore, the gap between the negative electrode current collector 11 and the electrolyte layer 15 does not increase during charging, and the gap between the negative electrode current collector 11 and the electrolyte layer 15 does not decrease during discharging. Thus, it is possible to suppress the thickness of the secondary battery 10 from varying with charging and discharging.

In the secondary battery 10 of the seventh embodiment, a coating layer that promotes the dissolution and deposition reaction of lithium metal may be provided on the surface of the pores of the porous layer 15b. The coating layer can make the dissolution and deposition reaction of lithium metal uniform. As such a coating layer, an alloy material or a carbon material can be used.

### Eighth Embodiment

Next, an eighth embodiment of the present disclosure will be described. Hereinafter, only portions different from the above embodiments will be described.

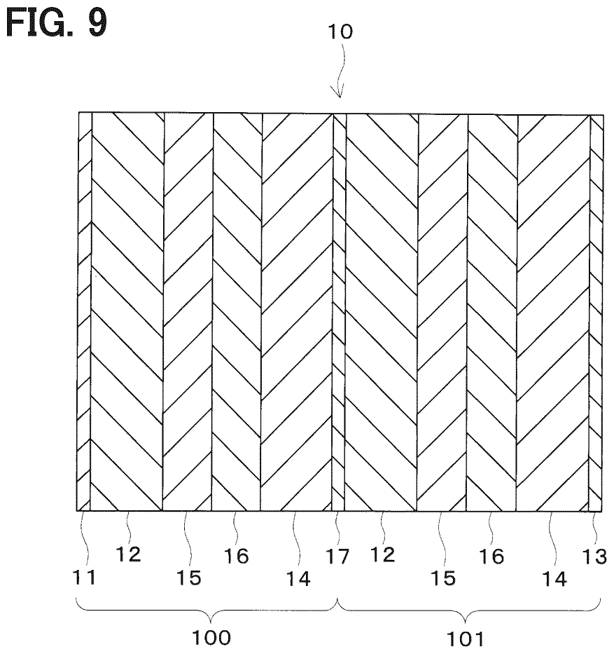

As shown in FIG. 9, the secondary battery 10 of the eighth embodiment has a bipolar structure. The secondary battery 10 of the eighth embodiment has plural battery cells 100 and 101. The battery cells 100 and 101 are stacked and connected in series. The number of battery cells 100, 101 constituting the secondary battery 10 can be arbitrarily set, and FIG. 9 shows an example in which two battery cells 100, 101 are provided in a stacked manner.

Each of the first battery cell 100 and the second battery cell 100 includes a negative electrode 12, an electrolyte layer 15, a shut layer 16, and a positive electrode 14. A common current collector 17 is provided between the first battery cell 100 and the second battery cell 101 adjacent to each other. The first battery cell 100 and the second battery cell 101 share the common current collector 17.

The common current collector 17 is supported between the positive electrode 14 of the first battery cell 100 and the negative electrode 12 of the second battery cell 101. The first battery cell 100 and the second battery cell are connected in series via the common current collector 17. Therefore, the positive electrode 14 of the first battery cell 100, the common current collector 17, and the negative electrode 12 of the second battery cell 101 form a bipolar structure.

The bipolar secondary battery 10 in the eighth embodiment is structurally likely to cause current unevenness, and is likely to cause lithium metal dendrites. In the bipolar secondary battery 10, the short circuit of the secondary battery 10 can be effectively suppressed by providing the shut layer 16.

### EXAMPLES

Next, examples of the present disclosure will be described. At least one of the lithium ion conductive solid material of the shut layer 16 and the positive electrode active material of the positive electrode 14 is made different among Examples 1 to 4. In addition, a secondary battery 10 in which the shut layer 16 is not provided is used as Comparative Example. In Examples 1 to 4 and Comparative Example, the configuration of the secondary battery 10 of the second embodiment is used.

In the secondary batteries 10 of Examples 1 to 4 and Comparative Example, the thickness of the negative electrode 12 is 25 μm, the thickness of the electrolyte layer 15 is 100 μm, and the thickness of the positive electrode 14 is 50 μm. In the secondary battery 10 of Examples 1 to 4, the thickness of the shut layer 16 is 10 μm.

In the secondary batteries 10 of Examples 1 to 4 and Comparative Example, the positive electrode 14 contains 50% of the positive electrode active material and 50% of the lithium ion conductive solid material. In Examples 1 to 3 and Comparative Example, LiNi_{0.8}CoMn_{0.1}O₂ (NCM811) is used, in which a layered active material is used as the positive electrode active material. In Example 4, LiMn_{0.8}Fe_{0.2}PO₄ (LMFP) is used, in which an olivine type active material is used as the positive electrode active material.

In the secondary batteries 10 of Examples 1 to 4 and Comparative Example, lithium metal is used as the negative electrode active material of the negative electrode 12, and Li₇La₃Zr₂O₁₂ (LLZO) is used as the electrolyte material of the electrolyte layer 15.

In Examples 1 and 4, Li_{1.25}La_{0.58}Nb₂O₆F, which is a pyrochlore solid electrolyte, is used as the lithium ion conductive solid material of the shut layer 16. In Example 2, Li_{1.4}Al_{0.4}Ti_{1.6}(PO₄)₃ (LATP), which is a NASICON type oxide solid electrolyte, is used as the lithium ion conductive solid material of the shut layer 16. In Example 3, La_{0.57}Li_{0.29}TiO₃ (LLTO), which is a perovskite type oxide solid electrolyte, is used as the lithium ion conductive solid material of the shut layer 16. In Comparative Example, the shut layer 16 is not provided.

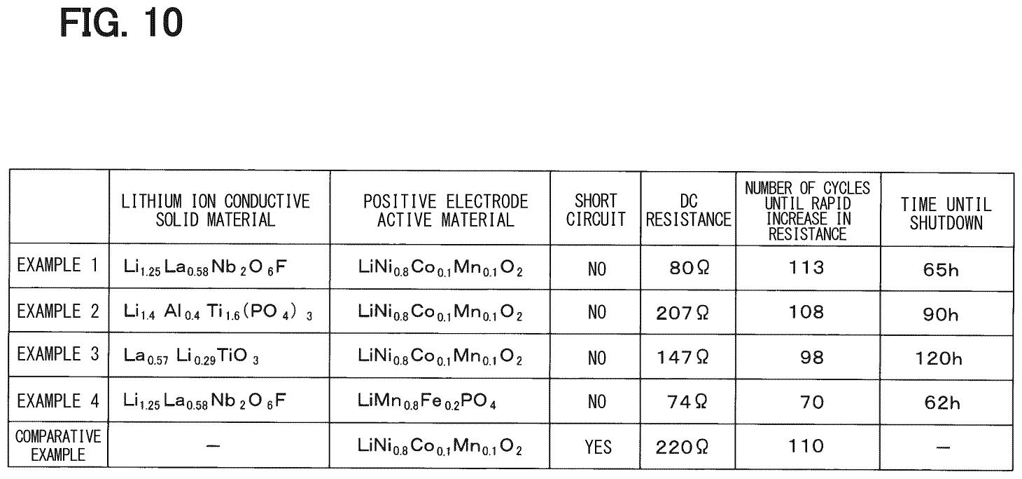

FIG. 10 shows the results of a cycle test in which the secondary battery 10 is repeatedly charged and discharged. In the cycle test, the presence or absence of a short circuit, the time from the rapid increase in the resistance of the secondary battery 10 to the shutdown, the DC resistance before the rapid increase in the DC resistance, and the number of cycles until the rapid increase in the resistance of the secondary battery 10 are measured. In the cycle test, the battery temperature is 10° C., the voltage is 4.3 V to 2.7 V, and the C rate is 0.2 C. The resistance of the secondary battery 10 is evaluated by measuring the resistance at an SOC of 50% using an AC impedance method. The rapid increase in resistance of the secondary battery 10 occurs when dendrites grow from the negative electrode 12 and the lithium ion conductive solid material contained in the shut layer 16 is reduced by contact with lithium metal.

As shown in FIG. 10, in Comparative Example in which the shut layer 16 was not provided, a short circuit occurred in the secondary battery 10 and the voltage became 0 V. In contrast, in Examples 1 to 4 in which the shut layer 16 was provided, the resistance of the secondary battery 10 increases before the voltage became 0 V, and charging and discharging of the secondary battery 10 are stopped while maintaining the voltage.

The number of cycles until the resistance of the secondary battery 10 rapidly increased is 113 in Example 1, 108 in Example 2, 98 in Example 3, 70 in Example 4, and 110 in Comparative Example. In Examples 1 to 3 in which the layered active material was used as the positive electrode active material, Example 1 has the largest number of cycles until the resistance of the secondary battery 10 rapidly increases. That is, when the pyrochlore solid electrolyte is used as the lithium ion conductive solid material, the number of times of charging and discharging of the secondary battery 10 can be further increased.

In addition, when Examples 1 and 4 using the pyrochlore type solid electrolyte are compared, in Example 4 using the olivine type active material as the positive electrode active material, the number of cycles until the resistance of the secondary battery 10 rapidly increases is significantly smaller than in Example 1 using the layered active material as the positive electrode active material. That is, when an olivine-type active material is used as the positive electrode active material of the secondary battery 10, dendrites are likely to be generated.

The time from when the resistance of the secondary battery 10 rapidly increases to the shutdown is 65 hours in Example 1, 90 hours in Example 2, 120 hours in Example 3, and 62 hours in Example 4. The secondary battery 10 of Comparative Example was not shut down. Among Examples 1 to 4, Examples 1 and 4 using the pyrochlore solid electrolyte show the shortest time from the rapid increase of the resistance of the secondary battery 10 to the shutdown. That is, when the pyrochlore solid electrolyte is used as the lithium ion conductive solid material, the secondary battery 10 can be shut down in a short time, and the safety of the secondary battery 10 can be further enhanced.

In addition, when Examples 1 and 4 using the pyrochlore type solid electrolyte are compared, the time until shutdown is shorter in Example 4 using the olivine type active material as the positive electrode active material than in Example 1 using the layered active material as the positive electrode active material. That is, in the secondary battery 10 using the olivine-type active material in which dendrites are easily generated, the occurrence of a short circuit can be effectively suppressed by providing the shut layer 16.

The DC resistance of the secondary battery 10 before the direct current resistance rapidly increases (that is, in a normal state) is 80Ω in Example 1, 207Ω in Example 2, 147Ω in Example 3, 74Ω in Example 4, and 220Ω in Comparative Example. The DC resistance of the secondary battery 10 in the normal state was the highest in Example 1. That is, Example 1 using the pyrochlore solid electrolyte has the most excellent input/output characteristics of the secondary battery 10.

The present disclosure is not limited to the above-described embodiments, and various modifications can be made without departing from the spirit of the present disclosure. The means disclosed in the individual embodiments may be appropriately combined as long as the combination is feasible.

While the present disclosure has been described with reference to embodiments thereof, it is to be understood that the disclosure is not limited to the embodiments and constructions. The present disclosure is intended to cover various modification and equivalent arrangements. In addition, although various combinations and modes are shown in the present disclosure, other combinations and modes including only one element, more than that, or less than that, are also within the scope and idea of the present disclosure.

What is claimed is:

1. A secondary battery comprising:
a positive electrode containing a positive electrode active material;
a negative electrode containing a negative electrode active material;
an electrolyte layer provided adjacent to the negative electrode and made of an electrolyte material having lithium ion conductivity; and
a shut layer provided adjacent to the positive electrode and containing a lithium ion conductive solid material having lithium ion conductivity, wherein
the electrolyte layer is interposed between the negative electrode and the shut layer,
the electrolyte material is a solid electrolyte, an electrolyte solution, a polymer, or a mixture thereof,
the shut layer is made of only the lithium ion conductive solid material or a mixture of the lithium ion conductive solid material and at least one of a solid electrolyte, an electrolytic solution, and a polymer,
the lithium ion conductive solid material is at least one of a pyrochlore solid electrolyte, a NASICON solid electrolyte, and a perovskite solid electrolyte, and
the lithium ion conductive solid material has a larger decrease in lithium ion conductivity when in contact with lithium metal than the electrolyte material.

2. A secondary battery comprising:
a positive electrode containing a positive electrode active material;
a negative electrode containing a negative electrode active material;
an electrolyte layer provided adjacent to the negative electrode and containing an electrolyte material having lithium ion conductivity; and
a shut layer provided adjacent to the positive electrode and containing a lithium ion conductive solid material having lithium ion conductivity, wherein
the electrolyte layer is interposed between the negative electrode and the shut layer, and
the lithium ion conductive solid material forms a non-conductor of lithium ion when in contact with lithium metal.

3. The secondary battery according to claim 2, wherein the lithium ion conductive solid material is at least one of a pyrochlore solid electrolyte, a NASICON solid electrolyte, and a perovskite solid electrolyte.

4. The secondary battery according to claim 1, wherein
the lithium ion conductive solid material is an oxide-based solid electrolyte having a pyrochlore structure represented by a composition formula Aa_{2-α}Ab_{(1+α)/3}B₂O_{7-β}X_{β} (Aa: alkali metal, Ab: lanthanoid, B: cationic metal, X: anion substitutable with O),
in the composition formula, α is within a range of 0.6<α<2.0, β is within a range of 0<β≤1, a sum of valences of cations composed of the Aa, the Ab, and the B and anions composed of the O and the X being negative, and a defective structure being included, and
the B is at least one of a Group 4 element, a Group 5 element, and a Group 15 element.

5. The secondary battery according to claim 4, wherein the B is at least one of Nb, V, Sb, Bi, Ta, Zr, Ti, and Hf.

6. The secondary battery according to claim 1, wherein the positive electrode active material includes an olivine type active material.

7. The secondary battery according to claim 1, wherein the negative electrode active material includes lithium metal.

8. The secondary battery according to claim 1, wherein the electrolyte material includes a solid electrolyte.

9. The secondary battery according to claim 1, comprising a negative electrode current collector, wherein
the negative electrode is not provided in an initial state in which charging is not performed, and
the negative electrode is formed to be in contact with the negative electrode current collector by charging.

10. The secondary battery according to claim 1, wherein
a plurality of battery cells is provided, each of which including the positive electrode, the negative electrode, the electrolyte layer, and the shut layer,
a common current collector is interposed between a positive electrode of one of the battery cells adjacent to each other and a negative electrode of the other of the battery cells, and
the one of the battery cells and the other of the battery cells are connected in series via the common current collector.
